(19) United States
(12) Patent Application Publication
(10) Pub. No.: US 2019/0100178 A1
(43) Pub. Date: Apr. 4, 2019

(54) PRESSURE SENSOR AND ELECTRONIC CONTROL BRAKE SYSTEM FOR VEHICLE HAVING THE SAME

(71) Applicant: MANDO CORPORATION, Pyeongtaek-si (KR)

(72) Inventor: Jung Wook SEO, Osan-si (KR)

(21) Appl. No.: 16/146,386

(22) Filed: Sep. 28, 2018

(30) Foreign Application Priority Data
Sep. 29, 2017 (KR) 10-2017-0127741

(51) Int. Cl. B60T 8/36; B60T 7/04

(52) U.S. Cl. CPC B60T 8/363; B60T 8/94; B60T 8/3655; B60T 7/042

(57) ABSTRACT

An electronic control brake system for a vehicle, comprising: a pressure sensor connected to an electronic control device for electrically controlling a brake hydraulic pressure and sensing the brake hydraulic pressure generated in a master cylinder, the electronic control device includes a PCB separated from the pressure sensor, and an elastic connecting body of a conductive material provided on the PCB, the pressure sensor includes a sensor housing, a sensing portion provided inside the sensor housing for sensing the brake hydraulic pressure, and a lead portion of inelastic and conductive material and having a first end electrically connected to the sensing portion while passing through the sensor housing and a second end exposed to the outside and electrically connected to the electronic control device.

### CROSS-REFERENCE TO RELATED APPLICATION

This application claims the benefit of Korean Patent Application No. P2017-0127741, filed on Sep. 29, 2017, in the Korean Intellectual Property Office, the disclosure of which is incorporated herein by reference in its entirety.

### 1. FIELD

The present disclosure relates to a pressure sensor, and more particularly to, an electronic control brake system for vehicle having the pressure sensor for sensing a brake hydraulic pressure generated in a master cylinder by a pressure of a brake pedal.

### 2. BACKGROUND

In general, a vehicle is equipped with a brake system for braking. Recently, various types of the brake systems have been proposed for obtaining a more powerful and stable braking force.

For example, such a brake system may include an anti-lock brake system (ABS) that prevents slippage of the wheel during braking, a brake traction control system (BTCS) that prevents slippage of the drive wheels and an electronic stability control system (ESC) that stably maintains the running state of the vehicle by controlling the brake hydraulic pressure by combining an anti-lock brake system and traction control.

In the conventional brake system, when a driver depresses a brake pedal, a hydraulic pressure necessary for braking is supplied to the wheel cylinder using a mechanically connected vacuum booster. In recent years, however, an electronic control brake system has been widely used in which, when a driver depresses a brake pedal, a brake pedal displacement sensor senses a displacement of the brake pedal and receives the driver's braking force as an electrical signal and supplies the hydraulic pressure necessary for braking to the wheel cylinder.

The electronic control brake system includes a modulator block equipped with a plurality of solenoid valves for adjusting the braking hydraulic pressure transmitted to the wheel brake, a low pressure accumulator, a high pressure accumulator, and the like and an electronic control device (ECU) for controlling the electrically operated above-mentioned components.

Further, the electronic control brake system includes a pressure sensor for sensing brake hydraulic pressure generated in the master cylinder by the urging force of the brake pedal in order to provide a stable braking force. The pressure sensor is also mounted on the modulator block.

### SUMMARY

Therefore, it is one aspect of the present invention to provide a pressure sensor capable of improving contact quality between a pressure sensor installed in a modulator block and an electronic control device electrically controlling the pressure sensor, and an electronic control brake system for a vehicle having the pressure sensor.

In accordance with one aspect of the present invention, an electronic control brake system for a vehicle includes: a pressure sensor connected to an electronic control device for electrically controlling a brake hydraulic pressure and sensing the brake hydraulic pressure generated in a master cylinder, the electronic control device includes a printed circuit board (PCB) separated from the pressure sensor, and an elastic connecting body of a conductive material provided on the PCB. The pressure sensor includes a sensor housing, a sensing portion provided inside the sensor housing for sensing the brake hydraulic pressure, and a lead portion of inelastic and conductive material and having one end of which is electrically connected to the sensing portion while passing through the sensor housing and the other end of which is exposed to the outside and is electrically connected to the electronic control device.

The elastic connecting body may be provided in a dome shape.

The lead portion may be provided in a bar shape of a metal material.

The lead portion is in surface contact with the elastic connecting body.

The lead portion includes a lead portion body extending from the sensing portion to extend through the sensor housing and a lead portion flange provided at an end of the lead portion body to extend a contact area with the PCB.

The lead portion flange is in close contact with the elastic connecting body while pressing the elastic connecting body.

In accordance with another aspect of the present invention, an electronic control brake system for a vehicle, includes: a pressure sensor connected to an electronic control device for electrically controlling a brake hydraulic pressure and sensing the brake hydraulic pressure generated in a master cylinder, the electronic control device including a PCB separated from the pressure sensor, and a contact point of a conductive material provided on the PCB. The pressure sensor including a sensor housing, a sensing portion provided inside the sensor housing for sensing the brake hydraulic pressure, and a lead portion of inelastic and conductive material and having a first end electrically connected to the sensing portion while passing through the sensor housing and a second end exposed to the outside and having an elastic contact body at its end so as to be electrically connected to the contact point.

The elastic contact body may be provided in a dome shape.

The lead portion may be in surface contact with the elastic contact body.

The lead portion includes a lead portion body extending from the sensing portion to extend through the sensor housing and a lead portion flange provided at an end of the lead portion body to extend a contact area with the PCB.

The lead portion body is provided in a bar shape of a metal material.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically showing a mounting state of a pressure sensor provided in an electronic control brake system according to one embodiment of the present invention;

FIGS. 2A and 2B are schematic view for explaining the contact between a PCB of the electronic control device and a lead portion of a pressure sensor provided in an the electronic control brake system according to one embodiment of the present invention;

FIG. 3 is a partial perspective view showing an elastic connecting body provided in the electronic control device of the electronic control brake system according to one embodiment of the present invention; and

FIG. 4 is a perspective view illustrating and elastic connecting body provided in an electronic control device of the electronic control brake system according to another embodiment of the present invention.

FIG. 5 is a schematic view for explaining the contact between a PCB of the electronic control unit and a lead portion of a pressure sensor provided in an electronic control brake system according to another embodiment of the present invention.

### DETAILED DESCRIPTION

Hereinafter, the embodiments of the present invention will be described in detail with reference to accompanying drawings. It should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

According to one embodiment of the present invention, an electronic control brake system for a vehicle may include a modulator block connected to a master cylinder and transfers a brake hydraulic pressure, and an electronic control device assembled with the modulator block and electrically controlling the brake hydraulic pressure.

In addition, the modulator block includes a plurality of solenoid valves for adjusting the brake hydraulic pressure so that the brake hydraulic pressure generated from the master cylinder is transmitted to the wheel brake, a low pressure accumulator in which the fluid escaping from the wheel brake is temporarily stored during the decompression braking operation, a motor for driving a pump to pump the fluid stored in the low pressure accumulator during the pressure increasing and the maintaining braking operation, and a high pressure accumulator directly connected to a discharge port side of the pump for reducing pressure pulsation of fluid pressurized and discharged by the pump driving. And a pressure sensor which is electrically connected to the electronic control device and senses the brake hydraulic pressure formed in the master cylinder is provided to the modulator block.

The electronic control device (ECU) controls the above-mentioned components that operate electrically.

The electronic control brake system can be controlled in various ways by the control operation of the electronic control device, the configuration of the hydraulic circuits, and the installation structure of the solenoid valves. For example, the electronic control brake system may be controlled by an anti-lock brake system (ABS), an electronically controlled hydraulic brake system (EHB), a vehicle attitude control system (EHB), and the like. Since the electronic control brake system is a well-known technique, a detailed description thereof will be omitted.

As described above, the pressure sensor according to the present embodiment is provided in the electronic control brake system to measure the brake hydraulic pressure generated from a master cylinder, and the electronic control device provides a stable braking force while controlling the brake hydraulic pressure of the vehicle.

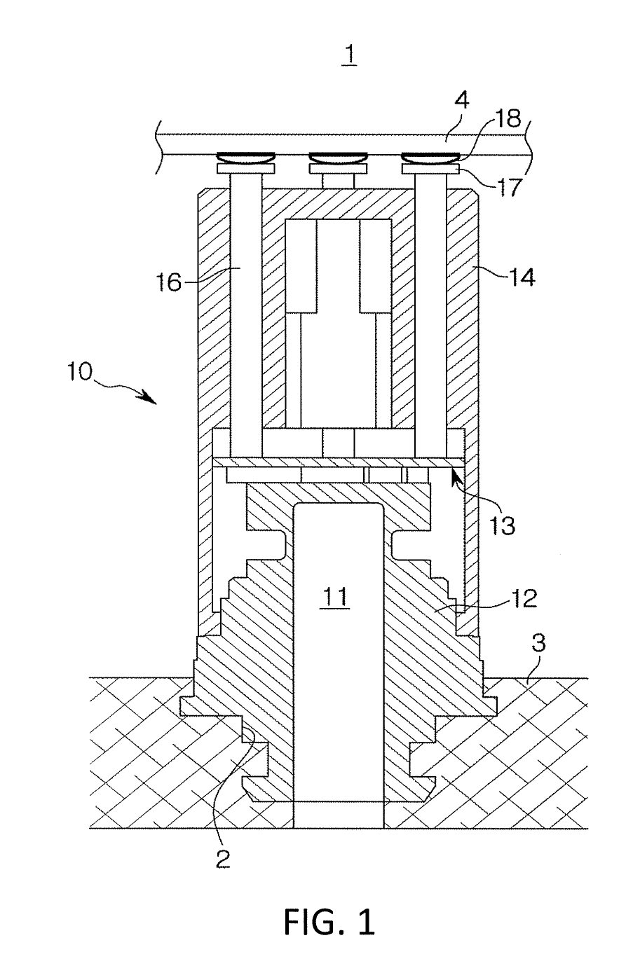

FIG. 1 is a view showing a mounting state of a pressure sensor provided in an electronic control brake system according to one embodiment of the present invention.

Referring to drawing, a pressure sensor 10 of an electronic control brake system 1 is installed in a modulator block 3 formed with a bore 2 so as to pass brake hydraulic pressure generated in a master cylinder and is electrically connected to a printed circuit board (PCB) 4 of the electronic control device (not shown) disposed in the vehicle body to sense the brake hydraulic pressure. The bore 2 formed in the modulator block 3 communicates with the master cylinder side flow passage.

The pressure sensor 10 includes a mounting portion 12 press-fitted into the bore 2 of the modulator block 3 and formed with a flow passage 11 so as to be connected to the flow passage of the master cylinder side, a sensing portion 13 provided on the mounting portion 12 for sensing the brake hydraulic pressure, a sensor housing 14 coupled to an upper portion of the mounting portion 12 and provided inside the sensing portion 13, and a lead portion 16 which penetrates the sensor housing 14 and has one end extending inward to be connected to the sensing portion 13 and the other end protruding to the outside to be connected to the PCB 4.

The pressure sensor 10 provided as described above measures the brake hydraulic pressure of the brake oil flowing through the flow passage 11 of the mounting portion 12 through the sensing portion 13. The measured information is transmitted to the PCB 4 as an electrical signal by the lead portion 16 made of an inelastic and conductive metal material that electrically connects the PCB 4 and the sensing portion 13 at both ends.

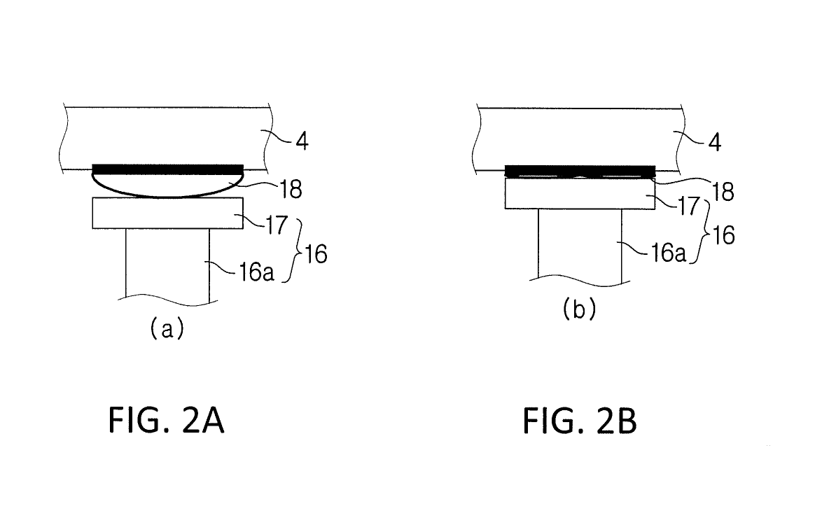

FIGS. 2A and 2B are views showing a state in which the pressure sensor mounted on the modulator block of the electronic control brake system according to the present embodiment is electrically connected to the electronic control device.

As illustrated in the drawing, the lead portion 16 provided to the pressure sensor 10 includes a lead portion body 16a formed in a long bar shape and protruding from the sensing portion 13 through the sensor housing 14, and a lead portion flange 17 extended at an end of the lead portion body 16a.

The lead portion body 16a and the lead portion flange 17 are made of a conductive metal, and they may be integrally formed or may be separated and then joined by welding or the like. The lead portion flange 17 is provided such that the width of the face of the electronic control device facing the PCB 4 is larger than the width of the lead portion body 16a so that the contact area with the PCB 4 is further enlarged.

The PCB 4 of the electronic control device may include an elastic connecting body 18 for enlarging the contact area with the lead portion 16.

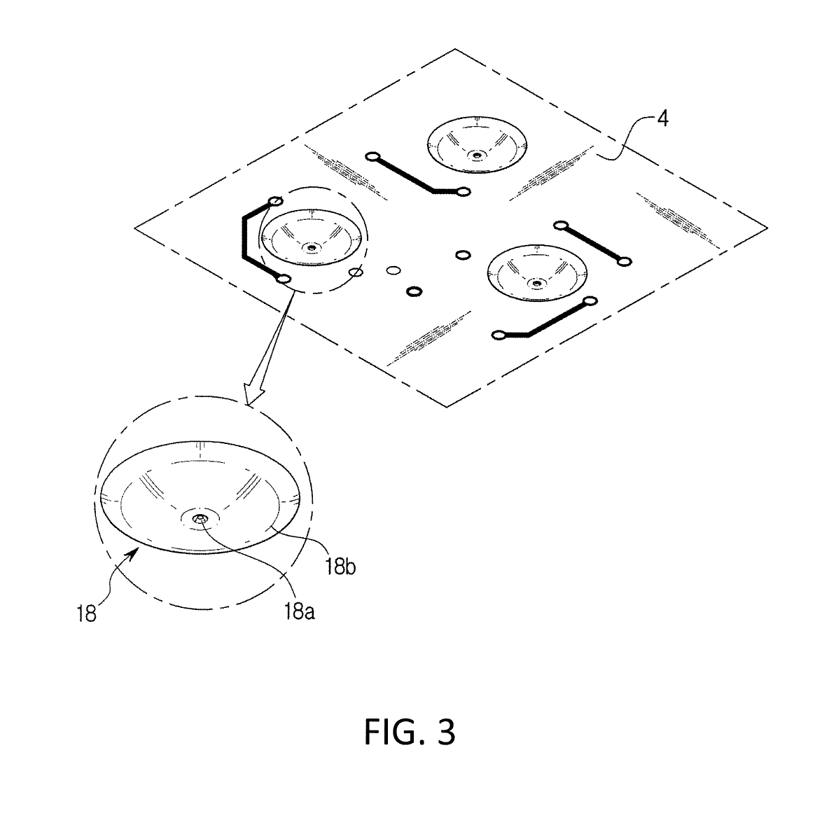

The elastic connecting body 18 is made of a conductive metal. The elastic connecting body 18 may be provided in the form of a dome whose center is protruded from the outer periphery by machining the metal plate into a press as shown in FIG. 3. An outer rim portion 18b of the dome-shaped elastic connecting body 18 is electrically connected to the PCB 4 and an inner central portion 18a may be electrically connected to the lead portion 16 of the pressure sensor 10.

The pressure sensor 10 and the PCB 4 provided as described above are in a state in which the lead portion flange 17 of the lead portion 16 is separated from the elastic connecting body 18 of the PCB 4 as shown in FIG. 2A and may be in close contact with each other while the lead portion flange 17 of the lead portion 16 is pressed to the elastic connecting body 18 of the PCB 4 as shown in FIG. 2B.

Therefore, since the pressure sensor 10 can maintain the tension at all times when the pressure sensor 10 contacts the PCB 4, there is no possibility that the connection is disconnected and the contact area is also widened, thereby ensuring the reliability of the quality of the pressure sensor 10 as well as the stable operation and braking force of the electronic control brake system.

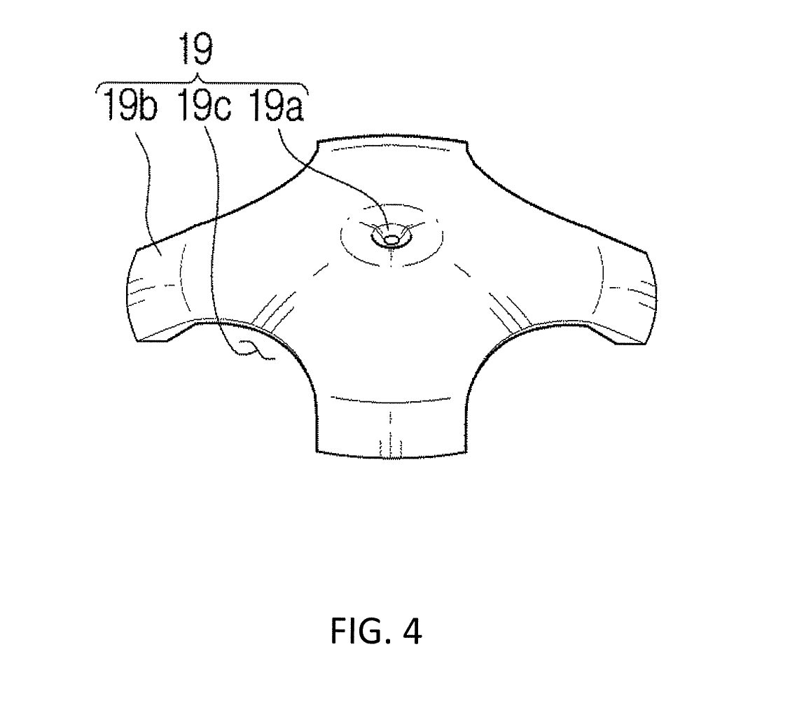

FIG. 4 is a view illustrating an elastic connecting body 19 provided on a PCB of an electronic control device of an electronic control brake system according to another embodiment of the present invention. The present embodiment will be described focusing on different points in one embodiment.

An elastic connecting body 19 according to the present embodiment is provided in a dome shape so that an inner central portion 19a is electrically connected to the lead portion flange 17 provided on the lead portion 16 of the pressure sensor 10 and an outer rim portions 19b are electrically connected to the PCB 4 of the electronic control device. Arc-shaped cutout grooves 19c are provided along the sides of the outer rim portions 19b of the elastic connecting body 19 so that the elastic deformation of the elastic connecting body 19 due to the pressing of the lead portion 16 may be easily achieved.

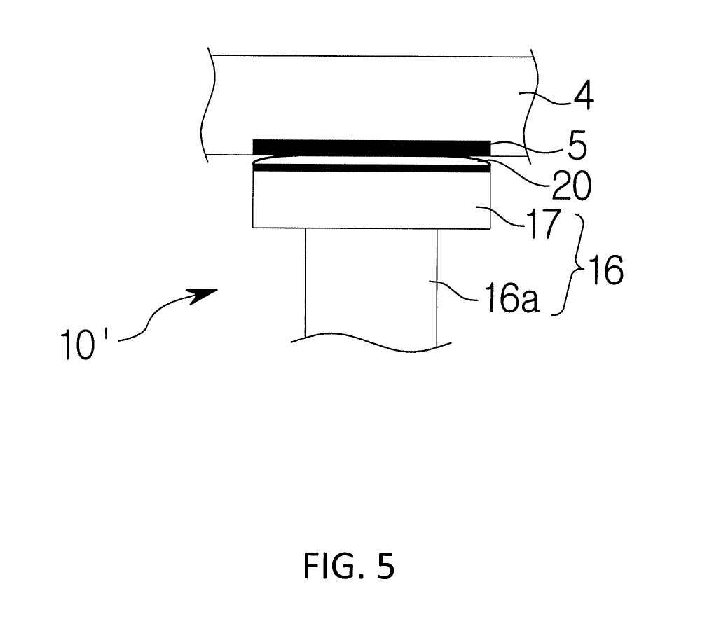

FIG. 5 is a schematic view for explaining the contact between a PCB of the electronic control device and a lead portion of the pressure sensor provided in an electronic control brake system according to another embodiment of the present invention. The present embodiment will be described mainly on the points different from the embodiment of FIGS. 2A and 2B, and the same reference numerals denote the same functions, and a detailed description thereof will be omitted.

As illustrated in the drawing, a lead portion 16 provided in a pressure sensor 10′ of the present embodiment includes a lead portion body 16a formed in a long bar shape, and a lead portion flange 17 extended at an end of the lead portion body 16a, and an elastic contact body 20 provided on the lead portion flange 17.

The lead portion body 16a and the lead portion flange 17 are made of an inelastic and conductive material, for example metal, and the elastic contact body 20 may be provided in the form of a dome whose center is protruded from the outer periphery by machining the metal plate into a press.

On the other hand, the PCB 4 of the electronic control device ECU includes a conductive contact point 5 so as to be electrically connected to the elastic contact body 20.

When the pressure sensor 10′ and the PCB 4 are assembled as shown in FIG. 5, the elastic contact body 20 of the lead portion 16 presses the contact point 5 of the PCB 4 and is in the surface contact therewith.

Therefore, since the pressure sensor 10′ can maintain the tension at all times when the pressure sensor 10′ contacts the PCB 4, there is no possibility of disconnecting the connection and the contact area is also widened, thereby ensuring the reliability of the quality of the pressure sensor 10 as well as the stable operation and braking force of the electronic control brake system.

In the pressure sensor and the electronic control brake system for a vehicle having the pressure sensor according to the embodiment of the present invention, the elastic connecting body of the conductive material provided on the PCB of the electronic control device and the lead portion provided in the metal bar of the inelastic material so as to connect to the pressure sensor are elastically contacted with each other, thereby the quality problem due to contact failure can be effectively solved.

Further, in the pressure sensor and the electronic control brake system having the pressure sensor according to the embodiment of the present invention, the elastic connecting body provided in a dome shape and the end portion of the lead portion of the pressure sensor provided in the flange shape are in the surface contact each other, thereby the contact cross-sectional area can be greatly increased as compared with the conventional one.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic control brake system for a vehicle, comprising: a pressure sensor connected to an electronic control device for electrically controlling a brake hydraulic pressure and sensing the brake hydraulic pressure generated in a master cylinder,
the electronic control device including a PCB separated from the pressure sensor, and an elastic connecting body of a conductive material provided on the PCB,
the pressure sensor comprising a sensor housing, a sensing portion provided inside the sensor housing for sensing the brake hydraulic pressure, and a lead portion of inelastic and conductive material and having a first end electrically connected to the sensing portion while passing through the sensor housing and a second end exposed to the outside and electrically connected to the electronic control device.

2. The electronic control brake system according to claim 1, wherein the elastic connecting body is provided in a dome shape.

3. The electronic control brake system according to claim 1, wherein the lead portion is in surface contact with the elastic connecting body.

4. The electronic control brake system according to claim 1, wherein the lead portion includes a lead portion body extending from the sensing portion to extend through the sensor housing and a lead portion flange provided at an end of the lead portion body to extend a contact area with the PCB.

5. The electronic control brake system according to claim 1, wherein the lead portion flange is in close contact with the elastic connecting body while pressing the elastic connecting body.

6. The electronic control brake system according to claim 5, wherein the lead portion body is provided in a bar shape of a metal material.

7. An electronic control brake system for a vehicle, comprising: a pressure sensor connected to an electronic control device for electrically controlling a brake hydraulic pressure and sensing the brake hydraulic pressure generated in a master cylinder,
the electronic control device including a PCB separated from the pressure sensor, and a contact point of a conductive material provided on the PCB,
the pressure sensor including a sensor housing, a sensing portion provided inside the sensor housing for sensing the brake hydraulic pressure, and a lead portion of inelastic and conductive material and having a first end electrically connected to the sensing portion while passing through the sensor housing and a second end exposed to the outside and having an elastic contact body at its end so as to be electrically connected to the contact point.

8. The electronic control brake system according to claim 7, wherein the elastic contact body is provided in a dome shape.

9. The electronic control brake system according to claim 7, wherein the lead portion is in surface contact with the elastic contact body.

10. The electronic control brake system according to claim 7, wherein the lead portion includes a lead portion body extending from the sensing portion to extend through the sensor housing and a lead portion flange provided at an end of the lead portion body to extend a contact area with the PCB.

11. The electronic control brake system according to claim 10, wherein the lead portion body is provided in a bar shape of a metal material.
